(19) United States
(12) Patent Application Publication
(10) Pub. No.: US 2012/0061457 A1
(43) Pub. Date: Mar. 15, 2012

(54) Carton With Angled Corner Panels

(75) Inventors: Rafael Gonzalez Rosas, Playas de Rosarito (MX); Gregory Vorce Hall, La Mesa, CA (US)

(73) Assignee: Orange County Container Group LLC, City of Industry, CA (US)

(21) Appl. No.: 13/230,557

(22) Filed: Sep. 12, 2011

Related U.S. Application Data
(60) Provisional application No. 61/381,610, filed on Sep. 10, 2010.

(51) Int. Cl. B26D 5/42

(52) U.S. Cl. 229/198.2

(57) ABSTRACT

A carton formed from a blank of foldable sheet material having two pairs of upstanding generally parallel sidewall panels and two upstanding diagonal corner panels. The corner panels are hingedly foldably connected to the sidewall panels intermediate and adjoining the sidewall panels. One pair of sidewall panels is attached to shaped flaps, which have one edge that abuts and rests against an adjoining sidewall panel and another edge that abuts and rests against an adjoining diagonal corner wall panel. The other pair of sidewall panels are hingedly foldably connected to cover forming flaps at their upper and lower edges to form the bottom and top panels of the carton. A reinforcing filler of styrofoam or other filler material may be used to support the bottom and top panels of the carton and diagonal corner wall panels.

### CROSS-REFERENCE TO RELATED APPLICATIONS

This application claims benefit of priority under 35 U.S.C. Section 119(e) to U.S. Provisional Application Ser. No. 61/381610, filed Sep. 10, 2010, entitled “Carton With Angled Corner Panels,” which is hereby incorporated herein by reference.

### FIELD OF THE INVENTION

The present invention relates to cartons with reinforced angled corner panels to protect products contained therein from damage.

### BACKGROUND OF THE INVENTION

Many cartons containing products are stored or transported under conditions in which lateral and vertical pressures are imposed upon the cartons. Accordingly, to provide adequate protection for the products, cartons must have substantial strength to prevent buckling and deformation.

### SUMMARY OF PARTICULAR EMBODIMENTS OF THE INVENTION

The present invention, in one embodiment, provides a carton formed from a single sheet of cardboard material, having four sidewall panels and one or more diagonal corner wall panels. At least one of the sidewall panels includes a shaped flap which has one edge that abuts and rests against an adjoining sidewall panel and another edge that abuts and rests against an adjoining diagonal corner wall panel in a self-positioning, supported relationship to provide a corner having substantial strength.

The present invention, in one embodiment, comprises a carton formed from a blank of foldable sheet material. The carton includes two pairs of upstanding generally parallel sidewall panels and two upstanding diagonal corner panels. Each of the corner panels is hingedly foldably connected to the sidewall panels intermediate and adjoining the sidewall panels. At least one pair of upstanding, generally parallel sidewall panels are hingedly foldably connected to respective cover forming flaps at their upper and lower edges to form the bottom and top panels of the carton. These flaps may have an extended angular tab on the side proximate the diagonal corner panels to provide a conforming cover for the area bounded by the diagonal corner panels.

The present invention, in another embodiment, also comprises a reinforcing filler for the corners of the carton, which filler may consist of styrofoam or other filler material or which may be manufactured from folded cardboard to fill the corners and wedge the product tightly in the carton. The fillers provide additional support at the top and bottom to secure and reinforce the shaped flap and diagonal corner wall panels. The filler may be shaped to provide a good fit for the product contained therein and to provide support for wall panels and corners to prevent crushing of the container during storage or handling operations.

### BRIEF DESCRIPTION OF THE DRAWINGS

The above mentioned and other features and objects of this invention and the manner of attaining them will become more apparent and the invention itself will be better understood by reference to the following description of an embodiment of the invention taken in conjunction with the accompanying drawings.

FIG. 1 is a perspective view of the assembled carton according to one embodiment of the present invention.

FIG. 2 is a plan view of the interior face of an unjoined, unfolded blank for the carton of FIG. 1.

FIG. 3 is a plan view of a joined, unfolded blank of FIG. 2

FIG. 4 is an enlarged broken away view of a portion of the interior face of the blank of FIG. 2.

FIG. 5 is a perspective view of the assembled carton of FIG. 1 illustrating the reinforced corner.

FIG. 6 is a perspective view of a reinforcing filler of another embodiment of the present invention.

FIGS. 7A, 7B and 7C are perspective views of a multiple piece reinforcing filler of another embodiment of the present invention.

Corresponding reference characters indicate corresponding parts throughout the several views of the drawings.

The drawings illustrate, among other things, various examples of embodiments of the invention, and certain examples of characteristics thereof. Other embodiments may differ. Different embodiments of the invention include various combinations of elements or acts shown in the drawings, described herein, known in the art, or a combination thereof, for instance.

### DETAILED DESCRIPTION OF A PREFERRED EMBODIMENT

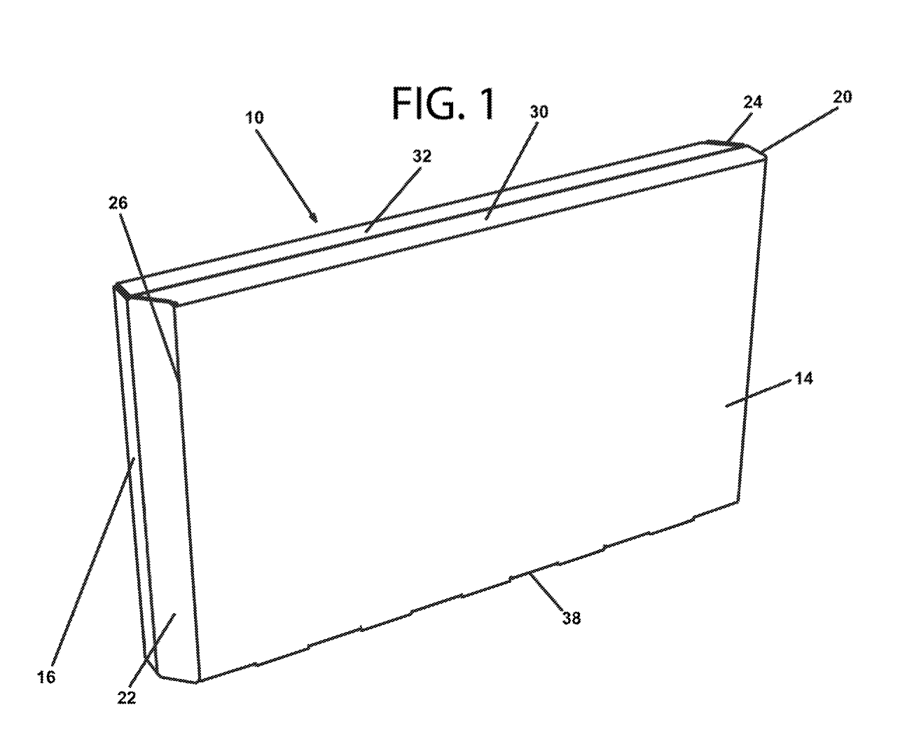

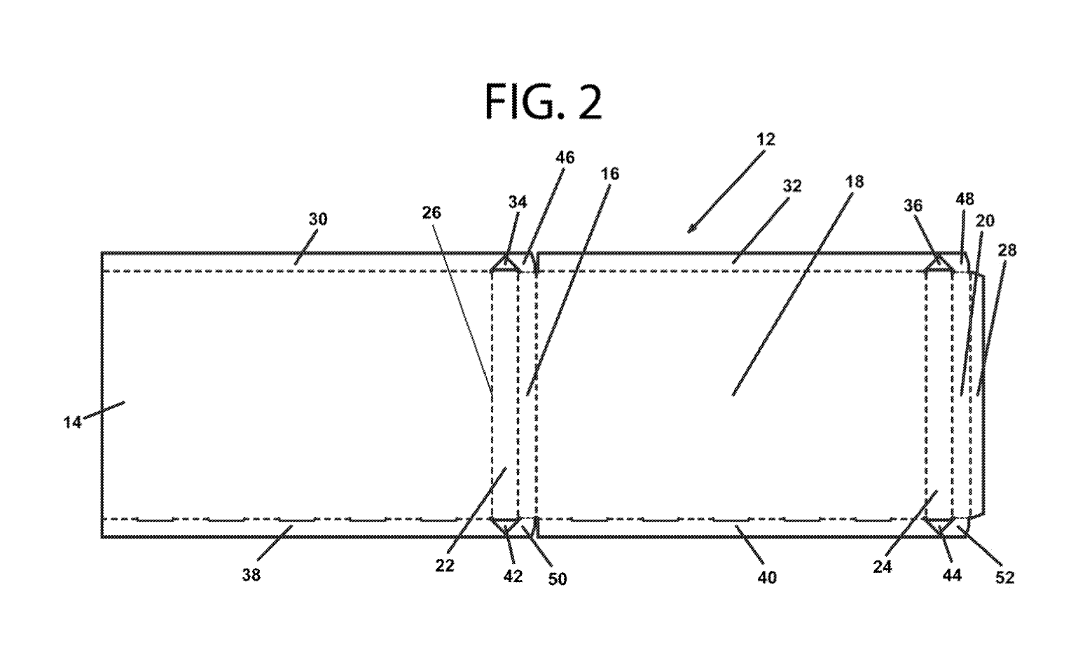

Referring to FIGS. 1 and 2, according to one embodiment of the present invention, there is shown a carton 10 which is formed of a sheet blank 12 of cardboard material or the like. As shown in FIG. 2, the unitary blank 12 includes sidewall panels 14, 16, 18 and 20. Two diagonal corner wall panels 22 and 24 are shown which respectively separate sidewall panels 14, 16 and 18, 20. In this preferred embodiment, sidewall panels 14 and 18 constitute one pair of parallel sidewall panels, and sidewall panels 16 and 20 constitute another pair of parallel sidewall panels. It should be noted that FIG. 2 illustrates the interior face of the blank 12, and the dotted lines 26 are fold lines along which blank 12 is folded inwardly toward the viewer in order to form the various flap and wall panels thereof as further described hereinafter.

An overlap portion 28 adjoins sidewall 20 whereby, when blank 12 is joined, overlap portion 28 may be secured to sidewall 14 such as by means of an adhesive.

FIG. 3 illustrates a blank 12 in a joined configuration, such that overlap portion 28 has been secured to sidewall 20, such as by means of an adhesive.

As shown in FIGS. 1 and 2, a top flap 30 also adjoins sidewall 14 at the top and bottom flap 38 adjoins sidewall 14 from the bottom. Similarly, top flap 32 adjoins sidewall 18 at the top, and bottom flap 40 adjoins sidewall 18 at the bottom.

Also as shown in FIGS. 1, 2, 4 and 5, angular shaped top flaps 46 and 48 adjoin sidewalls 16 and 20 at the tops and bottom, and similar angular shaped bottom flaps 50 and 52 adjoin sidewalls 16 and 20 respectively at the bottom. These angular shaped flaps 46, 48, 50, and 52 are configured so that, when the carton is assembled, one edge 54 of the flap 46, 48, 50, or 52 abuts and rests against the adjoining diagonal corner wall panel, and another edge 56 of the flap 46, 48, 50, or 52 abuts and rests against the adjoining sidewall panel. This configuration provides a self-positioning, supported relationship between the adjoining diagonal corner wall panel and the adjoining sidewall panel, resulting in an angled corner structure having substantial strength.

In one preferred embodiment, triangular portions of the sheet material are removed adjoining diagonal corner wall panels 22 and 24 at the top and bottom to form openings 34, 36, 42, and 44 respectively. These openings 34, 36, 42, and ,44 allow the non-rectangular configurations in the top and bottom flaps of parallel sidewalls 14 and 18, and in the top and bottom flaps of diagonal corner wall panels 22 and 24, as described in detail above. These openings also allow the upper and lower edges of diagonal corner wall panels 22 and 24 to extend above the fold lines between top flaps 30 32 and bottom flaps 38 and 40 and their adjoining sidewalls, and above the fold lines between angular shaped flaps 46, 48, 50, and 52 and their adjoining sidewalls, thus providing a substantial area on the interior surface of diagonal corner wall panels 22 and 24 for receiving the abutting flaps of the adjoining sidewall panels.

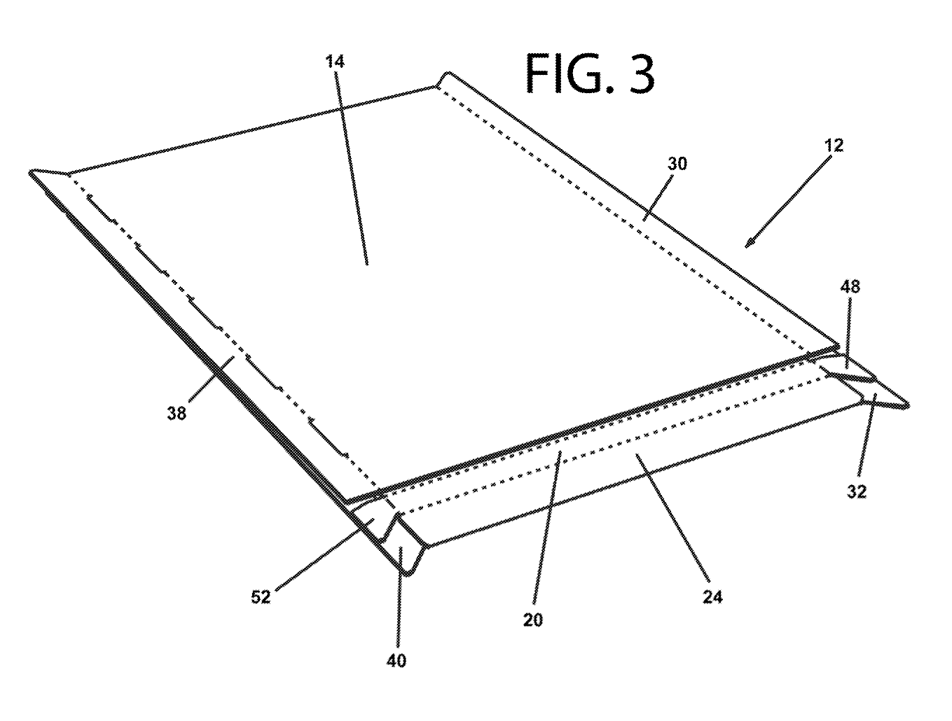

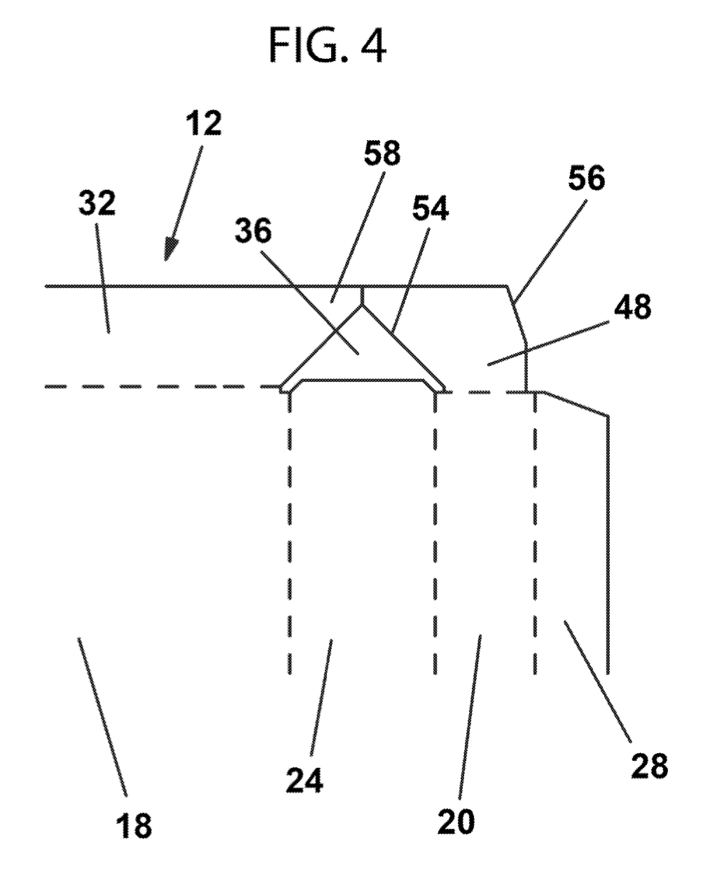

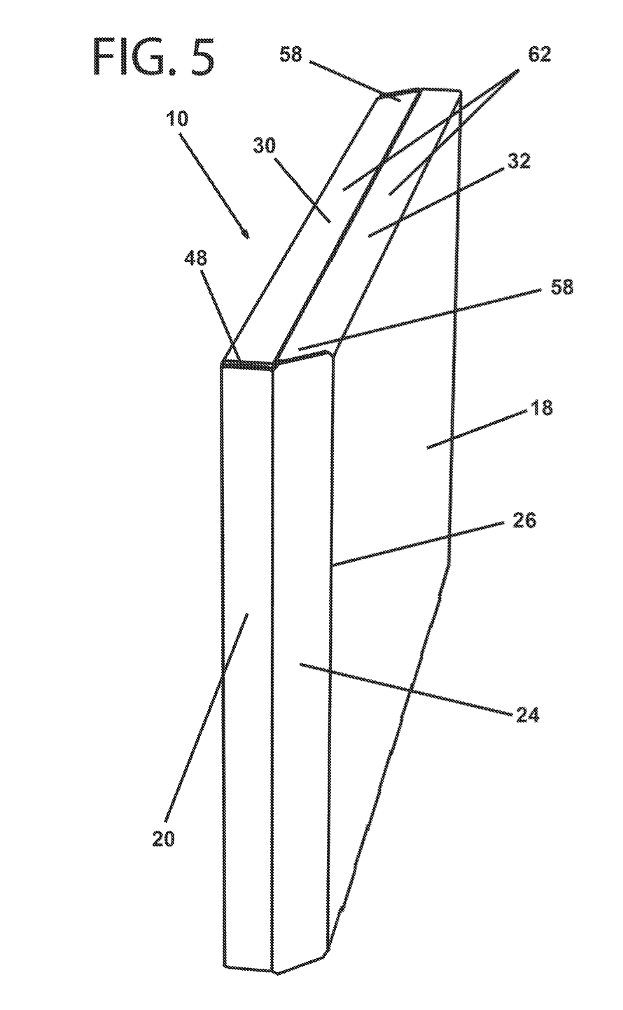

Also as shown in FIGS. 1, 4 and 5, in a preferred embodiment of the present invention, the top and bottom flaps 30, 32, 38 and 40 of the pair of upstanding generally parallel sidewall panels 14 and 18 are folded and sealed to form the top and bottom panels 62 and 64 (not shown) of the carton 10. As shown in FIGS. 4 and 5, these flaps have an extended angular tab 58 on the sides proximate the respective diagonal corner panels 22 and 24. This angular configuration provides conforming top and bottom panels 62 and 64 which cover the complete top and bottom of the carton 10, including the areas of the top and bottom adjacent the diagonal corner panels 22 and 24.

Also, the angular shape of these extended angular tab 58 on the sides proximate the respective diagonal corner panels 22 and 24 provides a configuration such that when the carton is assembled, one edge of the tab 58 abuts and rests against the adjoining diagonal corner wall panel. This configuration provides a self-positioning, supported relationship between the adjoining diagonal corner wall panel and the adjoining sidewall panel, resulting in an angled corner structure having substantial strength.

In another embodiment, rather than removing triangular portions of the sheet material adjoining diagonal corner wall panels 22 and 24 at the top, flaps may be formed from the triangular portions of the sheet material adjoining diagonal corner wall panels 22 and 24 at the top and bottom. These triangular flaps may form a potion of, and reinforce the top and bottom covers of the carton 10.

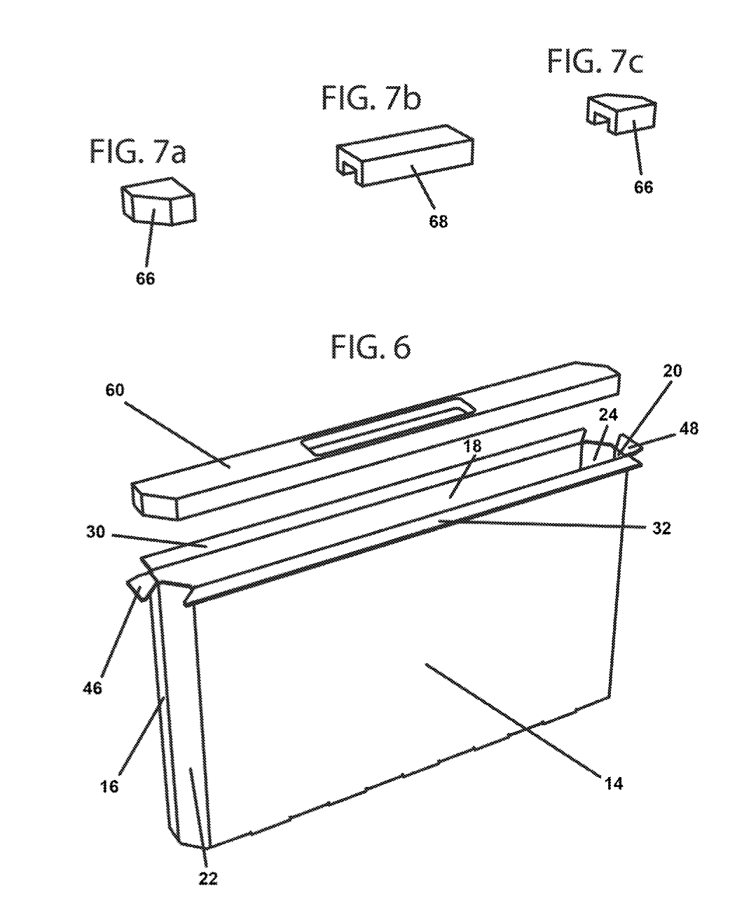

As shown in FIG. 6, in another embodiment of the present invention, a reinforcing filler 60 is provided for at least the diagonal corners of the carton. The reinforcing filler 60 may consist of styrofoam or other suitable filler material, such as folded or formed plastic or cardboard, to fill and support the corners of the carton 10 and wedge the product tightly in the carton. The fillers 60 provide additional support at the top and bottom panels 62 and 64 to secure and reinforce the angular shaped flaps 46, 48, 50, and 52 and diagonal corner wall panels 22 and 24. The filler 60 may be shaped to provide a conforming fit for the product contained therein and to provide strength to wall panels and corners to prevent crushing of the container during storage or handling operations.

As shown in FIGS. 7A, 7B and 7C, in another embodiment of the present invention, a multiple piece reinforcing filler comprises corner pieces 66 and center component 68. Corner pieces 66 provide additional support at the top and bottom panels 62 and 64 to secure and reinforce the angular shaped flaps 46, 48, 50, and 52 and diagonal corner wall panels 22 and 24. The corner pieces 66 and center component 68 may be shaped to provide a conforming fit for the product contained therein and to provide strength to wall panels and corners to prevent crushing of the container during storage or handling operations.

In essence, in one embodiment the present invention comprises a carton formed from a blank of foldable sheet material having two pairs of upstanding, generally parallel sidewall panels, two upstanding corner panels, each said corner panel hingedly foldably connected to two of said sidewall panels intermediate and adjoining said sidewall panels; and a pair of first flaps hingedly foldably connected to each of the first pair of said parallel sidewall panels, the flaps configured to form a panel for covering the top and bottom of the carton when the carton is assembled, and a pair of second flaps hingedly foldably connected to each of the second pair of said parallel sidewall panels, the flaps configured to abut an adjoining sidewall panel and to abut an adjoining corner panel when the carton is assembled.

In essence, in one embodiment the present invention comprises a carton formed from a blank of foldable sheet material having two pairs of upstanding, generally parallel sidewall panels, two upstanding corner panels, each said corner panel hingedly foldably connected to two of said sidewall panels intermediate and adjoining said sidewall panels, a pair of first flaps hingedly foldably connected to each of the first pair of said parallel sidewall panels, the flaps configured to abut each other to form a panel for covering the top and bottom of the carton and to abut an adjoining corner panel when the carton is assembled, and a pair of second flaps hingedly foldably connected to each of the second pair of said parallel sidewall panels, the flaps configured to abut an adjoining sidewall panel and to abut an adjoining corner panel when the carton is assembled.

In essence, in one embodiment the present invention comprises a carton for containing a product formed from a unitary sheet of corrugated material having two pairs of upstanding, generally parallel sidewall panels, said pairs of sidewall panels are oriented perpendicular to one another, two upstanding corner panels, each said corner panel hingedly foldably connected to two of said sidewall panels intermediate and adjoining said sidewall panels, a pair of first flaps hingedly foldably connected to each of the first pair of said parallel sidewall panels, the flaps configured to abut each other to form a panel for covering the top and bottom of the carton and to abut an adjoining corner panel when the carton is assembled, a pair of second flaps hingedly foldably connected to each of the second pair of said parallel sidewall panels, the flaps configured to abut an adjoining sidewall panel and to abut an adjoining corner panel when the carton is assembled; and a reinforcing filler inserted within the interior of the carton fitted into the corner formed by a adjoining portions of one of the flaps, one of the sidewall panels and one of the corner panels and shaped to provide a conforming fit for the product.

While this invention has been described as having preferred designs, it will be understood that it is capable of further modification. This application is therefore intended to cover any variations, uses or adaptations of the invention following the general principles thereof and including such departures from the present disclosure as come within known or customary practice in the art to which this invention pertains and fall within the limits of the appended claims.

What is claimed is:

1. A carton formed from a blank of foldable sheet material comprising:
two pairs of upstanding, generally parallel sidewall panels;
two upstanding corner panels, each said corner panel hingedly foldably connected to two of said sidewall panels intermediate and adjoining said sidewall panels;
a pair of first flaps hingedly foldably connected to each of the first pair of said parallel sidewall panels, the flaps configured to form a panel for covering the top and bottom of the carton when the carton is assembled; and
a pair of second flaps hingedly foldably connected to each of the second pair of said parallel sidewall panels, the flaps configured to abut an adjoining sidewall panel and to abut an adjoining corner panel when the carton is assembled.

2. The carton according to claim 1 wherein said blank consists of a unitary sheet of corrugated material.

3. The carton according to claim 1 wherein said pairs of sidewall panels are oriented perpendicular to one another.

4. The carton according to claim 1 wherein the pair of first flaps are configured to abut an adjoining corner panel when the carton is assembled.

5. The carton according to claim 1 wherein the pair of first flaps are configured to abut each other when the carton is assembled.

6. The carton according to claim 1 further comprising at least one reinforcing filler inserted within the interior of the carton.

7. The carton according to claim 6 wherein the reinforcing filler is fitted into the corner formed by a adjoining portions of one of the flaps, one of the sidewall, panels and one of the corner panels.

8. The carton according to claim 6 wherein the reinforcing filler extends across the top or bottom of the carton.

9. The carton according to claim 6 wherein the carton is for containing a product, and the reinforcing filler is shaped to provide a conforming fit for the product.

10. A carton formed from a blank of foldable sheet material comprising:
two pairs of upstanding, generally parallel sidewall panels;
two upstanding corner panels, each said corner panel hingedly foldably connected to two of said sidewall panels intermediate and adjoining said sidewall panels;
a pair Of first flaps hingedly foldably connected to each of the first pair of said parallel sidewall panels, the flaps configured to abut each other to form a panel for covering the top and bottom of the carton and to abut an adjoining corner panel when the carton is assembled; and
a pair of second flaps hingedly foldably connected to each of the second pair of said parallel sidewall panels, the flaps configured to abut an adjoining sidewall panel and to abut an adjoining corner panel when the carton is assembled.

11. A carton for containing a product formed from a unitary sheet of corrugated material comprising:
two pairs of upstanding, generally parallel sidewall panels, said pairs of sidewall panels are oriented perpendicular to one another;
two upstanding corner panels, each said corner panel hingedly foldably connected to two of said sidewall panels intermediate and adjoining said sidewall panels;
a pair of first flaps hingedly foldably connected to each of the first pair of said parallel sidewall panels, the flaps configured to abut each other to form a panel for covering the top and bottom of the carton and to abut an adjoining corner panel when the carton is assembled;
a pair of second flaps hingedly foldably connected to each of the second pair of said parallel sidewall panels, the flaps configured to abut an adjoining sidewall panel and to abut an adjoining corner panel when the carton is assembled; and
a reinforcing filler inserted within the interior of the carton fitted into the corner formed by a adjoining portions of one of the flaps, one of the sidewall panels and one of the corner panels and shaped to provide a conforming fit for the product.
